(19) United States
(12) Patent Application Publication
(10) Pub. No.: US 2019/0329546 A1
(43) Pub. Date: Oct. 31, 2019

(54) SHEET PROCESSING MACHINE AND METHOD FOR MONITORING SHEET TRAVEL

(71) Applicant: KOENIG & BAUER AG, Würzburg (DE)

(72) Inventor: Jürgen VEIL, Steinbach (DE)

(21) Appl. No.: 16/468,326

(22) PCT Filed: May 8, 2018
(86) PCT No.: PCT/EP2018/061895

§ 371 Date: Jun. 11, 2019

(30) Foreign Application Priority Data
May 8, 2017 (DE) 10 2017 207 706.9

(51) Int. Cl. B41F 21/14; B65H 11/00; B65H 7/14

(52) U.S. Cl. CPC B41F 21/14; B65H 11/007; B65H 2801/42; B65H 2553/42; B65H 7/14

(57) ABSTRACT

A sheet processing machine, in particular a sheet-fed printing press or a sheet die cutting machine, has a sheet infeed having at least one stop for feeding and aligning sheets, and has a device for monitoring sheet travel along a sheet transport path of the sheet infeed. At least one measurement system, for detecting a lateral sheet edge of the sheet, is provided. A method is also provided for monitoring sheet travel along a sheet transport path in a sheet infeed. An alternative device and an alternative method for monitoring sheet travel along a transport path of a sheet processing machine are provided. At least one sensor, which can be associated with the lateral region of the sheet transport path, and which is configured for the optical detection and determination of the position of a mark on the sheet, is utilized.

### CROSS REFERENCE TO RELATED APPLICATIONS

This application is the U.S. National Phase, under 35 U.S.C. § 371, of PCT/EP2018/061895, filed May 8, 2018; published as WO 2018/206588 A1 on Nov. 15, 2018, and claiming priority to DE 10 2017 207 706.9, filed May 8, 2017, the disclosures of which are hereby expressly incorporated by reference in their entireties.

### FIELD OF THE INVENTION

The present invention relates to a sheet processing machine, in particular a sheet-fed printing press or a sheet-fed die-cutting machine, especially a sheet-fed rotary die-cutting machine, having a sheet infeed system and having a device for monitoring sheet travel along a sheet transport path of the sheet infeed system; the invention further relates to a method for monitoring sheet travel along a sheet transport path in a sheet infeed system.

### BACKGROUND OF THE INVENTION

In a processing machine, for example, in particular in a web-fed printing press, printed webs receive a trimming cut during the production process that is within a certain tolerance range. This tolerance range is generally between 0.1 and 0.15 mm. At the end of the printing process these webs are cut into sheets using a sheeter. These sheets can then be processed as needed, for example in a sheet-fed offset process. With a finishing process, for example, it is possible to print into or onto the preprinted subject. For this purpose, the preprinted sheets must be fed in and/or aligned with a very high degree of precision.

From DE 26 41848 A1, a method and a device for positioning sheets for printing presses and the like are known, in which the sheets are first mechanically prepositioned by being slidably inserted along a stop bar into a positioning device until the sheet leading edge abuts against a stop that is moved temporarily into the sheet path; using edge marks, fine positioning is then controlled such that the edge marks assigned to the leading corners are moved successively, by the appropriate displacement of the paper sheet, each into the scanning area of a respectively assigned electro-optical scanning system; and finally, the paper sheet is moved away from the stop bar, parallel thereto, until the edge marks assigned to the longitudinal side reach the area of the electro-optical scanning systems.

In a device known from DE 36 44431 A1, the actual position of the sheet to be aligned is determined on the feed table by means of a measuring device and is compared with a predefined target position in an evaluation unit. If the actual position deviates from the target position, a corrective signal is generated, actuating a corrective element that communicates with the gripper system of a downstream drum. The corrective element displaces the gripper system such that the sheet to be aligned, which is being held by the gripper system, is moved into the target position with respect to its lateral edge. To avoid faulty measurements by the measuring device in sensing the actual position due to minor defects or fibers on the lateral edge, DE 195 06467 A1 proposes providing at least three measuring devices that operate independently of one another. The measuring devices are arranged side by side within a short section that runs parallel to the lateral edge to be measured, to determine a plurality of measured values. From the measured values determined for a position of the lateral edge, a measurement result is generated using a mathematical calculation that suppresses extreme values of the measured values that can be attributed to anomalies of the lateral edge.

DE 102 08570 A1 describes a device for aligning sheets along a lateral edge, in which the actual position of a sheet to be aligned, which has arrived at front lays, is detected by a measuring device on a feed table, and the sheet is transferred by a sheet accelerating device to a gripper system of a drum, the gripper system being disposed slidably to achieve a target position in the axial direction.

From DE 103 57864 A1, a device for detecting the position of an edge of a sheet-format material to be processed is known, in which an optoelectrical measuring device is assigned to a sheet clamp for securing the lateral edge of the sheet-format processing material on the feed table.

From WO 2012/076671 A1 a method and a device for aligning a sheet upstream of a sheet processing machine is known, in which an arriving sheet is moved with its leading edge against a stop and is thereby decelerated to a standstill, and then the sheet is clamped in the region of its leading edge on each longitudinal side by a clamping device, after which a camera is used to record images, one of the right front region of the sheet and one of the left front region of the sheet, to determine the actual position, wherein the image information from the camera is then compared with stored target values, and the corrective movement that is necessary to achieve the target position of the sheet is calculated, after which the stop at the sheet leading edge is moved out of the transport plane and the calculated corrective movement is carried out, the two clamping devices being moved independently of one another in and transversely to the transport direction.

From DE 10 2010 027119 A1 a method and a device for positioning sheets are known, in which positioning takes place without the use of front stops or lateral stops. The sheet is positioned roughly in the circumferential and oblique directions by stopping the sheet in a controlled manner, the sheet is aligned laterally in the region of a feed table, and the sheet is positioned precisely in the circumferential and oblique directions by positioning register stops of a sheet transport system. The sheet positions can also be measured by measuring the sheet edge and register marks. One disadvantage of this solution is that the rough alignment by means of transport and press systems can also result in damage to the printed image. Measuring the position of the sheet in the circumferential and oblique directions while the sheet is in motion is likewise associated with difficulties.

From DE 10 2008 012775 A1 a method for measuring the position of sheets and for aligning sheets is known, in which the sheets are moved over a feed table in the sheet transport direction via belts. A sheet is prealigned mechanically using front lay marks and side lay marks. In this prealigned position, a sensor detects the leading edge of the sheet or register marks that are printed on the sheet. To compensate for a difference between an actual position and a target position, the lateral position of the sheet is corrected by a lateral alignment system integrated into the feed table. Disadvantages of this solution are the alignment along side lay marks and the need for integration of the lateral alignment system into the feed table.

From DE 10 2009 027861 A1, a method for aligning the lateral edges of printed sheets is known, in which a respective printed sheet that has been measured with respect to its lateral edge position by a sensor is displaces transversely to the transport direction on the feed table by an actuating device on the feed table in order to align the lateral edge of said printed sheet, but without the respective printed sheet coming to rest against a lateral edge stop as a result of the displacement transversely to the transport direction.

### SUMMARY OF THE INVENTION

The object of the present invention is to provide an alternative device and an alternative method for monitoring sheet travel along a transport path of a sheet processing machine, in particular a sheet infeed system. In particular, the object is to devise an improved sheet infeed system without side lay marks and/or without large-scale pressing systems.

According to the present invention, the object is attained by the provision of a sheet processing machine, in particular a sheet-fed printing press or a sheet-fed dye cutting machine, having a sheet infeed system that has at least one stop for the positioning and alignment of sheets. A device for monitoring sheet travel along a sheet transport path of the sheet infeed system in provided. This device includes at least one measuring device for detecting a lateral sheet edge of the sheet. At least one sensor, which can be assigned to the lateral region of the sheet transport path and which is configured to optically detect and ascertain the position of a mark on the sheet, is provided. A method for monitoring the sheet travel along a sheet transport path in a sheet infeed system of a sheet processing machine, in particular in a sheet-fed printing press or in a sheet-fed dye-fed cutting machine, and having a device comprising at least one measuring device for detecting the lateral region of the sheet, includes providing at least one sensor which can be assigned to the lateral region of the sheet transport path and which is configured to optically detect the lateral region of a sheet. The measuring device and the sensor are connected to an analysis unit which processes the measured values from the measuring device and the sensor, in succession. The invention has the advantage that an alternative device or an alternative method for monitoring sheet travel along a transport path of a sheet processing machine is provided. In particular, an improved sheet infeed system without side lay marks and/or without large-scale pressing systems is created.

The advantages achieved by the invention are, in particular, that a sensor detects the preprinted side lay marks on the sheet and the sheet is aligned by means of grippers in such a way that the preprinted sheets can be fed in or aligned in precisely the correct position.

Particularly advantageously, a rough alignment can be carried out based upon a detected lateral edge of the sheet, followed by a precision alignment based upon the mark or the printed image. The rough alignment enables the temporarily required framework for a precision alignment based upon lay marks or the printed image to be created, which is necessary for recording and processing the image content. This further enables the attainment of higher machine speeds.

In a further refinement, a lay mark can be analyzed twice, with an analysis unit processing the two measurements successively. In that case, the first measurement is preferably optimized for rapid analysis, to enable a time-critical prealignment of a gripper system, for example. A subsequent second measurement of the lay mark, preferably by the same sensor, is then optimized for a precise analysis, to enable an ultimately highly precise fine control of the gripper system, for example. With the two-part measurement process, positioning can be accomplished both rapidly and with high precision, resulting in faster machine speeds.

### BRIEF DESCRIPTION OF THE DRAWINGS

The invention will be described in greater detail in the context of an exemplary embodiment. In the accompanying drawings,

FIG. 1 shows a side view of a sheet infeed system;

FIG. 2 shows a plan view of a section of a feed table;

FIGS. 3 to 5 show schematic diagrams of possible sheet positions in relation to two receivers;

FIG. 6 depicts a lay mark on a sheet;

FIG. 7 shows an embodiment of a sheet infeed system of a processing machine;

FIG. 8 shows a plan view of the feed table without sheets to be aligned;

FIG. 9 shows section A-A from the previous drawing;

FIG. 10 shows section B-B of the previous drawing;

FIG. 11 shows a feed table with a sheet having at least one register mark.

### DESCRIPTION OF PREFERRED EMBODIMENTS

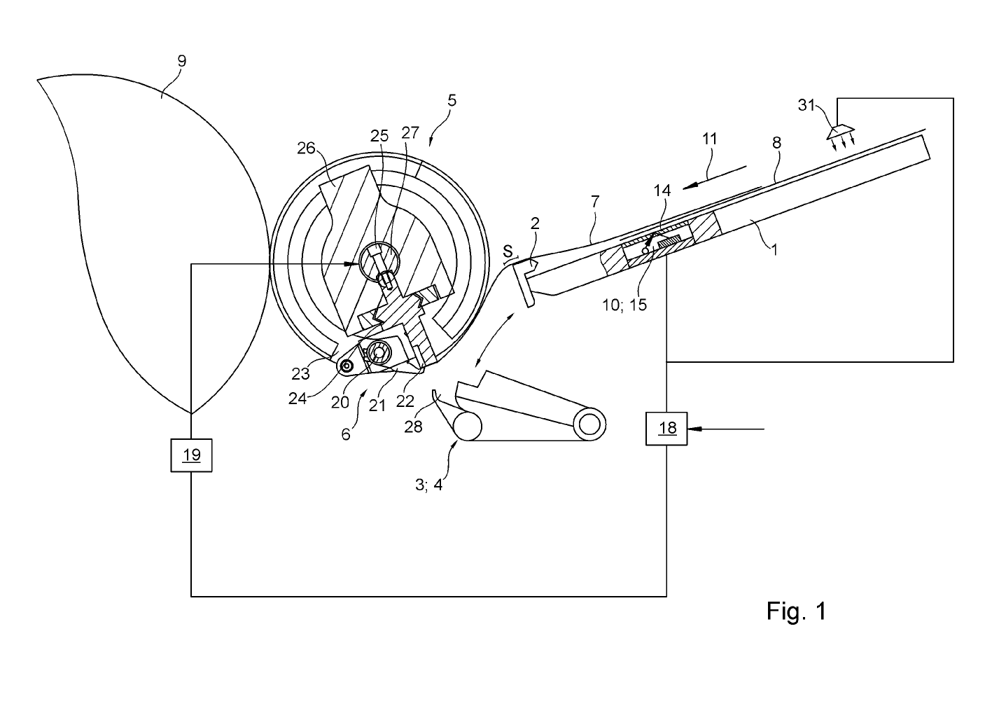

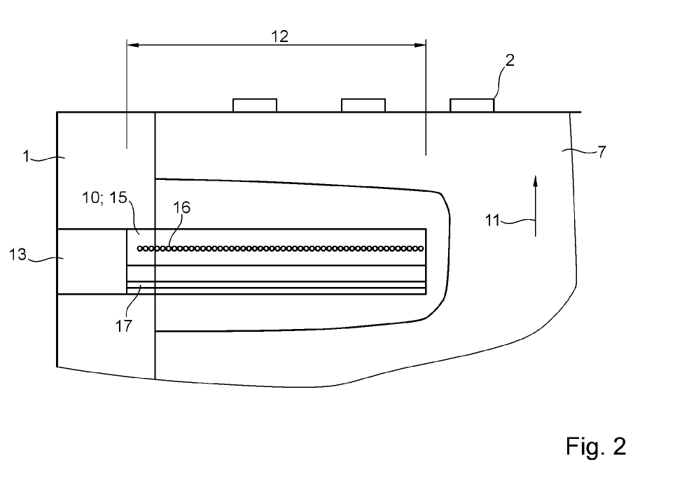

FIGS. 1 and 2 show a preferred sheet infeed system, for example for a sheet-fed printing press, in particular a sheet-fed offset printing press, preferably in a unit-based and inline configuration, said sheet infeed system comprising a feed table 1 with front lays 2, a sheet accelerating device 3, preferably configured as a swing arm 4 and including a sheet holding system 28, and a drum 5, in which a gripper system 6 is arranged such that it is displaceable axially. A cylinder 9 is preferably disposed downstream of drum 5. The upper table surface of feed table 1 forms a sheet transport path along which sheets 7, 8, 30 can be fed to other units of the sheet processing machine, e. g. to sheet holding system 28 of swing arm 4. A sheet 7 to be aligned, which has been grasped by gripper system 6, and a follower sheet 8 are shown on feed table 1.

A measuring device 10, which extends at least over a format area 12 characteristic of every machine and in which the lateral edge of the incoming sheet 7, 8, 30 can be detected, is preferably assigned to feed table 1. Format area 12 extends transversely to a conveying direction 11. In the exemplary embodiment, a channel 13 is provided in feed table 1, extending transversely to conveying direction 11, and measuring device 10 is arranged therein. Channel 13 is closed off by a transparent cover strip 14, so that the surface of feed table 1 and of cover strip 14 form a common plane. Measuring device 10 is an optoelectrical measuring device 10, e. g. configured as a reflex array 15, a CCD array, or a camera. However, any other measuring principle may also be used. Reflex array 15 preferably comprises a lighting device 16 extending over the entire length of measuring device 10, and a receiver 17 located in a position adjacent and parallel to lighting device 16 and extending approximately within the same plane as and also over the entire length of measuring device 10. Alternatively or in addition to the arrangement of receiver 17 depicted, at least one receiver 29 may be assigned to the opposite lateral region of the sheet transport path.

A receiver 17, 29 may be formed from individual CCD elements connected in series or as a scanner array extending over the entire format area 12. The CCD elements preferably consist of a multiplicity of measuring elements arranged side by side in a row. For the configuration of receiver 17, 29, it is irrelevant whether it is part of measuring device 10, whether it is associated with a lighting device 16, or specifically how it is structured, provided it is configured for the optical detection of the lateral region of one or more superimposed sheets 7, 8, 30. A single receiver 17, 29 or each receiver may also comprise two CCD arrays, which are inclined at different angles with respect to the sheet transport path. According to a further embodiment, a single receiver 17, 29 or each receiver may also be arranged above the sheet transport path.

Receiver 17, 29 is connected to an analysis unit 18. Analysis unit 18 analyzes the signals of the at least one receiver 17, 29 to determine the position of the lateral edge of the sheet or of the superimposed sheets 7, 8, 30. In addition, the thickness of the sheet or of the superimposed sheets 7, 8, 30 may also be determined. Target values for the lateral sheet position and optionally for the sheet thickness can be entered into or stored in analysis unit 18. Analysis unit 18 is preferably linked to an actuating element 19 or a drive of the sheet processing machine. Actuating element 19 can in turn be operatively connected to gripper system 6 of drum 5. Gripper system 6 preferably comprises gripper fingers 21, which are clamped on a gripper shaft 20 and which correspond to gripper pads 22. Gripper system 6 is preferably arranged as a functional unit on a carriage 24, which is mounted displaceably in a drum channel 23. A driver 25, which is connected to an actuating shaft 27 guided concentrically within a drum body structure 26, engages with carriage 24. Actuating element 19, by which gripper system 6 can be displaced in the axial direction, corresponds with actuating shaft 27.

From a belt table, not shown in FIG. 1, the sheet 7 to be aligned is conveyed onto feed table 1 with the leading edge of said sheet against the front lays 2 located in a position on feed table 1, where said sheet is halted and thus aligned with the leading edge. A selected lateral edge of sheet 7 to be aligned, which is preferably stationary, is detected by receiver 17, 29. For this purpose, if receiver 17, 29 is configured as a reflex array 15, beams are preferably emitted by lighting device 16; these beams are then reflected by the underside of sheet 7 to be aligned and are detected by receiver 17, 29. In the region that is covered by sheet 7 to be aligned, beams emitted by lighting device 16 are reflected, indicating the position of the lateral edge on receiver 17, 29.

With a suitable arrangement and configuration of lighting device 16 and of the receiver or receivers 17, 29, it is also possible for a lateral surface of a respective sheet 7, 8, 30, i.e. a lateral surface delimited by the leading, the trailing, the upper, and the lower lateral edges of a respective sheet side, to be included as a reflective surface and mapped to, i.e. detected, by receiver 17, 29. Lighting device 16 and receiver 17, 29 are preferably arranged in such a way that the light radiation emitted by lighting device 16 or the radiation of any other light source is reflected on the underside of the respective sheet 7, 8, 30 to a different extent, in particular a different proportion, from the reflection from the lateral surface. On receiver 17, 29, areas that are irradiated with different intensities that can be associated with the source of their reflection, i.e. the underside of the respective sheet 7, 8, 30 or the lateral surface thereof, are mapped according to their reflectance. The signal generated by receiver 17, 29 is supplied to analysis unit 18, where it is processed and optionally stored.

Afterward, the sheet 7 to be aligned, the leading edge of which is resting at front lays 2, is grasped by sheet accelerating device 3 and removed from feed table 1, and the front lays 2 are guided into a position underneath feed table 1. If sheet accelerating device 3 is configured as a swing arm 4, the sheet 7 to be aligned is clamped by sheet holding system 28 and is then removed from feed table 1. Above feed table 1, a sensor 31 is arranged, which determines the position of a mark 32 of sheet 7, 8, 30, which is clamped, in particular, by sheet holding system 28.

Measuring device 10 can perform a measurement as soon as sheet 7 arrives, for example, to determine the position of the lateral edge of sheet 7. This measurement can take place even before the leading edge of sheet 7 has reached the front lays 2, for example at a distance of 100 mm. Alternatively or additionally, a measurement can be performed while sheet 7 is in the stationary position, at the front lays 2. In a further refinement, the position of the lateral edge of sheet 7 to be aligned, which is in a state of movement, can also be detected by receiver 17, 29 by a series of measurements, with the additional generated signals being supplied to analysis unit 18, during a first phase of removal from the feed table, in which the leading edge of sheet 7 to be aligned travels a distance s, with s being approximately 2 to 10 mm. In analysis unit 18, a mean value is calculated from the first signal and the other signals of a measurement cycle, and any values that exceed a predefined tolerance, i.e. actual values that were initiated by anomalies along the lateral edge, are masked out and thus are not factored in. This mean value reflects the position of the lateral edge of sheet 7 to be aligned and is compared with the target value stored in analysis unit 18. Analysis unit 18 can likewise analyze the signal of receiver 17, 29 with respect to the thickness of the detected sheet or sheets 7, 8, 30.

If the ascertained actual value of sheet 7 to be aligned deviates from the target value, a corrective signal is generated by analysis unit 18 and is supplied to actuating element 19. Once sheet 7 to be aligned has been transferred from sheet accelerating device 3 or swing arm 4 to gripper system 6 of drum 5, actuating element 19 displaces gripper system 6 far enough in the axial direction to move the lateral edge of sheet 7 to be aligned from its actual position to the target position. The aligned sheet 7 is then transferred in the target position from drum 5 to cylinder 9. While sheet 7 to be aligned is being transported to drum 5, follower sheet 8 is transported to a point with its leading edge against the front lays 2 positioned on feed table 1, where said sheet is aligned and its movement halted. Measuring device 10 or reflex array 15 detects the actual position of the lateral edge of follower sheet 8 in an analogous manner, and this position is supplied to analysis unit 18.

If the value for the thickness of a sheet 7, 8, 30, ascertained by analysis unit 18 in a further refinement, is greater than a stored value, analysis unit 18 will generate a multiple-sheet signal, which it will forward to at least one drive of the sheet processing machine to induce said drive to decelerate or shut down. The time at which the receiver or receivers 17, 29 optically detect(s) the lateral region of one or more superimposed sheets 7, 8, 30 may vary in accordance with different embodiments. In general, it is possible to use one and the same signal to determine the thickness of one or more sheets 7, 8, 30 and to detect the position of the lateral edge of the single sheet or the superimposed sheets 7, 8, 30 based upon said same signal; it is also possible to use each of a number of different signals, i.e. signals detected at different times, to determine the thickness of one or more sheets 7, 8, 30 and the position of the lateral edge of the single sheet or the superimposed sheets 7, 8, 30.

According to a preferred embodiment, receivers 17, 29 detect a signal from the lateral region of one or more superimposed sheets 7, 8, 30 before the respective sheet 7, 8, 30 is aligned at its leading edge, and analysis unit 18 analyzes this signal to determine the thickness of the single sheet or the superimposed sheets 7, 8, 30. Once the leading edge of the same sheet 7, 8, 30 has been aligned, an additional signal is detected by the same receiver 17, 29 and is analyzed to determine the position of the lateral edge of the single sheet or the superimposed sheets 7, 8, 30. This has the advantage, in particular, that the system can respond early to multiple sheets by activating the intake barrier, thereby preventing damage to the machinery, while the lateral edge of the single sheet or the superimposed sheets 7, 8, 30 is detected and analyzed comparatively late, i.e., after its alignment, and a signal representing the position of the lateral edge is used following a comparison with a target value to actuate an actuating element 19.

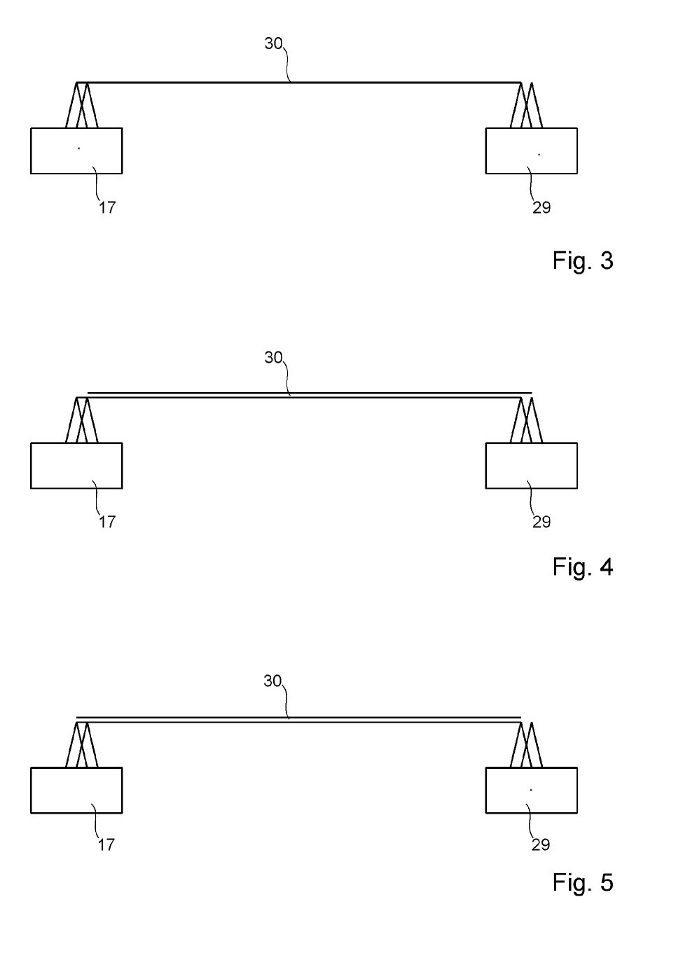

FIG. 3 depicts a laterally offset single sheet 30 in positional reference to an embodiment having two receivers 17, 29. The position of the lateral edges and the thickness of the sheet are detected by both receivers 17, 29.

FIG. 4 shows two sheets 30 (i.e., multiple sheets) offset laterally and relative to one another, in positional reference to an embodiment having two receivers 17, 29. Receiver 17 detects only the position of the left lateral edge and the thickness of the lower sheet 30. Receiver 29 detects the position of the lateral edges of the upper and lower sheets 30 and the thickness of the lower and upper sheets 30.

FIG. 5 depicts two laterally offset single sheets 30 in a superposed position (i.e., a double sheet) in positional reference to an embodiment having two receivers 17, 29. The position of the lateral edges and the thickness of the double sheet 30 are detected by both receivers 17, 29.

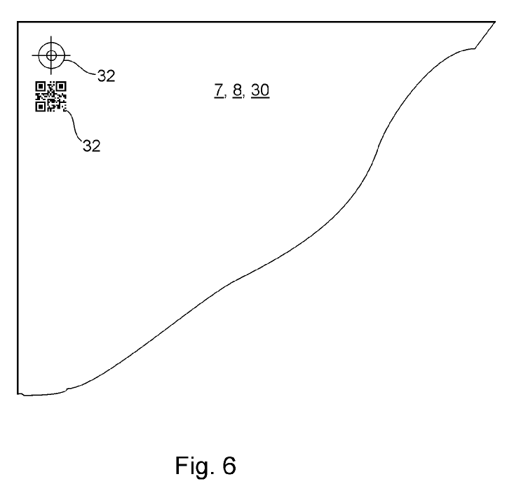

FIG. 6 shows marks 32 to be detected on a sheet 7, 8, 30 by at least one sensor 31. A mark 32 may be configured as a register mark and/or code, e. g. as a QR code. The device for monitoring sheet travel along a sheet transport path in the sheet infeed system of a sheet processing machine comprises at least one sensor 31, which is assigned to the lateral region of the sheet transport path and is configured for the optical detection of the lateral region of a sheet 7, 8, 30. Sensor 31 is arranged so as to ascertain the position of a mark 32, e. g. a register mark, of the sheet 7, 8, 30. Sheet 7, 8, 30 preferably has the mark 32 even before the sheet 7, 8, 30 is fed into the sheet processing machine. Preferably, sensor 31 is arranged such that it detects the top surface of sheet 7, 8, 30. Sensor 31 is particularly preferably arranged above the sheet transport path, in particular above feed table 1 or swing arm 4. Advantageously, sensor 31 is displaceable transversely to the transport path. Sensor 31 is configured, as a camera, a CCD camera, or a CMOS camera, for example. Preferably, sensor 31 is connected to an analysis unit or the analysis unit 18, with analysis unit 18 being arranged such that it can analyze the signals from sensor 31 to assess the position of mark 32. Based upon the signal from sensor 31, actuating element 19 is actuated, for example to adjust the position of gripper system 6. The signal from sensor 31 is preferably used for the fine positioning of gripper system 6.

Advantageously, analysis unit 18 analyzes the signals from measuring device 10 to determine the position of the lateral edge of the single sheet 7, 8, 30 and emits a signal that represents the lateral position of sheet 7, 8, 30. Analysis unit 18 preferably analyzes the signals from receiver 17, 29 and sensor 31 and forwards a signal representing the lateral position of sheet 7, 8, 30 or a correction or actuating signal to actuating element 19 to influence the sheet position. Measuring device 10 for detecting the lateral region of sheet 7, 8, 30 and sensor 31 can be operated on an optional basis, with measuring device 10 influencing in particular the rough positioning of each sheet 7, 8, 30 and sensor 31 influencing the fine positioning. Each sheet 7, 8, 30 is aligned based upon both the measured values from measuring device 10 and the measurement result from sensor 31, wherein first a rough alignment along the lateral edge is carried out, followed by a precision alignment according to the mark 32.

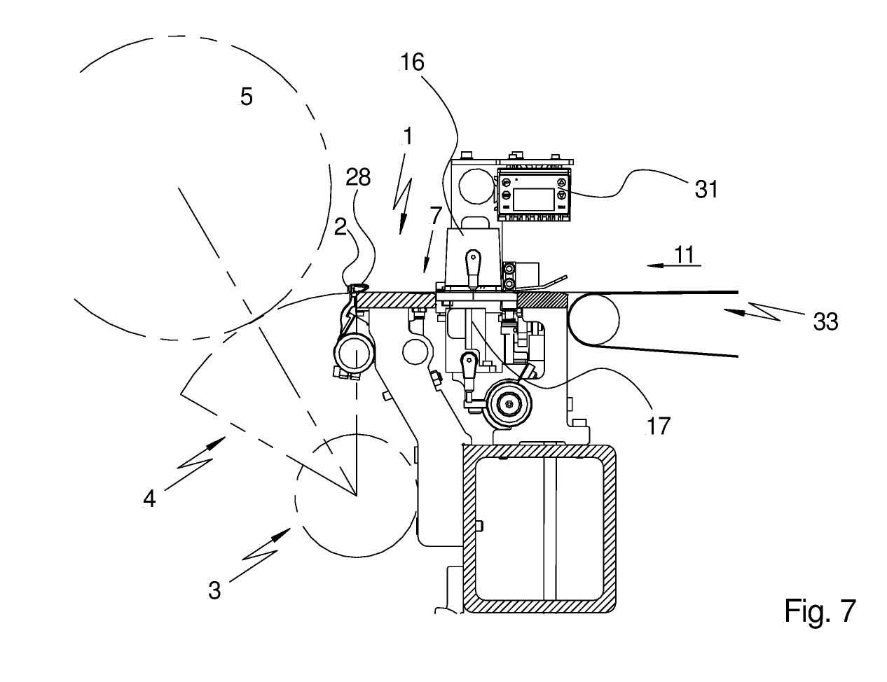

FIG. 7 shows one embodiment of a sheet infeed system of a sheet processing machine, in particular as a post-press processing machine, in particular of a sheet-fed offset printing press in a unit-based and inline configuration, as described above. The sheet infeed system may also be part of a rotary die cutter. A sheet infeed system may be provided, for example, in a material logistics system, for example in a press room in which a processing material will be further processed, in particular finished. In this case, a printing substrate may be processed, for example printed, in sheet format or web format in an upstream processing machine. When web-format printing substrate is used, the printing substrate is cross-cut, in particular in a preceding process step, to produce sheet-format materials for processing, in particular sheets 7, 8, 30. Processing material that has been prepared in this way is fed to the sheet infeed system of the sheet processing machine for further processing. The sheet processing machine can, in particular, die-cut the sheets 7, 8, 30 and/or finish them in a finishing process, for example in a printing unit, a coating unit, and/or a finishing unit. In particular, the sheet processing machine may include a film transfer module for applying film layers that can be overprinted, for example, for finishing.

In particular, at least one marking is applied to the sheet-format processing material in the upstream operation. For example, in an upstream printing process, for example on the web-fed printing press, one or more marks 32, together in particular with a constant printed image, may be applied to the surface of the printing substrate, in particular to each of the later sheets 7, 8, 30. The sheets 7, 8, 30 can be stacked for further processing, for example, in particular in a feed unit upstream of the sheet infeed system. The machines provided for upstream processing and for further processing may come from different manufacturers, for example.

For the precise infeed of the sheet-format material for processing, in particular sheets 7, 8, 30, the sheet infeed system of the sheet processing machine may be equipped with a belt table 33 having at least one perforated, revolving conveyor belt, to which a negative pressure is preferably applied. The at least one conveyor belt may be provided, for example, at least approximately centered along the width of the machine. However, it is also possible for multiple conveyor belts to be provided one behind the other in conveying direction 11 and/or side by side. In that case, the negative pressure and/or the transport speed of the conveyor belts can also be individually controlled or regulated.

Feed table 1 with front lays 2 is situated downstream of belt table 33 in conveying direction 11. The upper run of the conveyor belt of belt table 33 and the upper table surface of feed table 1 form the sheet transport path, which in particular can represent a transport plane. A sheet 7 to be aligned is preferably positioned at the front lays 2 of feed table 1. The sheet infeed system further comprises a sheet accelerating device 3, preferably configured as a swing arm 4 and having a sheet holding system 28, and a drum 5, in which a gripper system 6 (not described in greater detail) is arranged such that it is displaceable axially. The remainder of the machine can be embodied as described above and may comprise, for example, a cylinder 9 (not shown) downstream of drum 5.

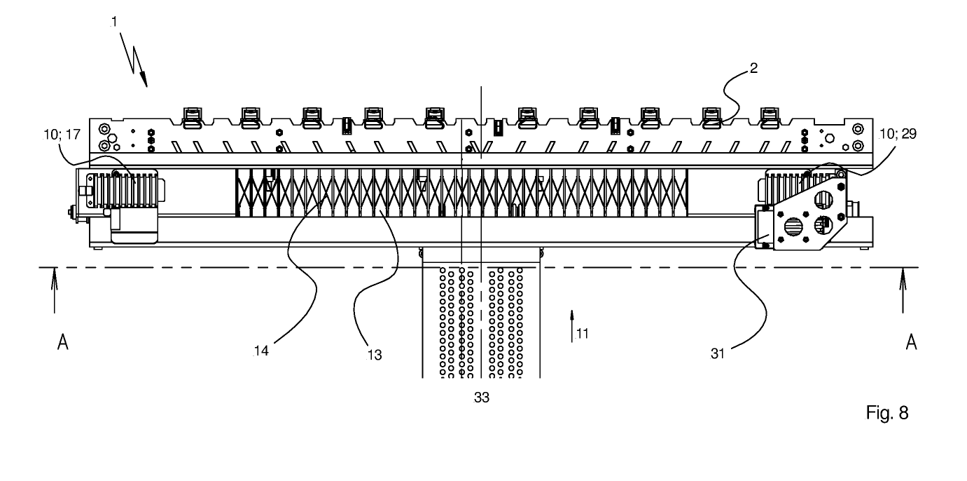

FIG. 8 shows a plan view of feed table 1 without a sheet 7 to be aligned. In particular, a channel 13 extending transversely to conveying direction 11 is provided upstream of front lays 2 in feed table 1, in which channel the at least one measuring device 10 is arranged. Channel 13 is covered by a covering element, such as a scissor lattice 14, with the surfaces of feed table 1 and covering element in particular forming a common plane. Lateral edge sensors 17, 29 are preferably assigned to feed table 1, in particular to channel 13, with each active lateral edge sensor 17, 29 detecting a respective lateral edge of the incoming sheets 7, 8, 30, as described above. In particular, one lateral edge sensor 17 is assigned to a first lateral edge of a sheet 7 and another lateral edge sensor 29 is assigned to the opposite lateral edge thereof. Sensors 17, 29 are configured, in particular, as optoelectrical systems, for example as CCD arrays or scanner arrays.

Preferably, the lateral edge sensors 17, 29 of a respective lighting device 16 are arranged opposite one another, i.e., lighting devices 16 are arranged above feed table 1. For example, a lateral edge sensor 17, 29 can be moved or displaced parallel to and preferably together with the respective lighting device 16 transversely to conveying direction 11. In particular, each activated lateral edge sensor 17, 29 together with the assigned lighting device 16 can be adjusted to the current sheet format, i.e., to the sheet lateral edge to be detected. Preferably, position control is carried out based upon a lateral edge sensor 17, 19, which is activated following the appropriate selection of the pull side. In the illustrated embodiment, a sensor 31 for detecting mark 32 on sheets 7, 8, 30 is assigned to the lateral edge sensor 29 assigned to side 2. However, the opposite lateral edge sensor 17 may also be connected to such a sensor 31.

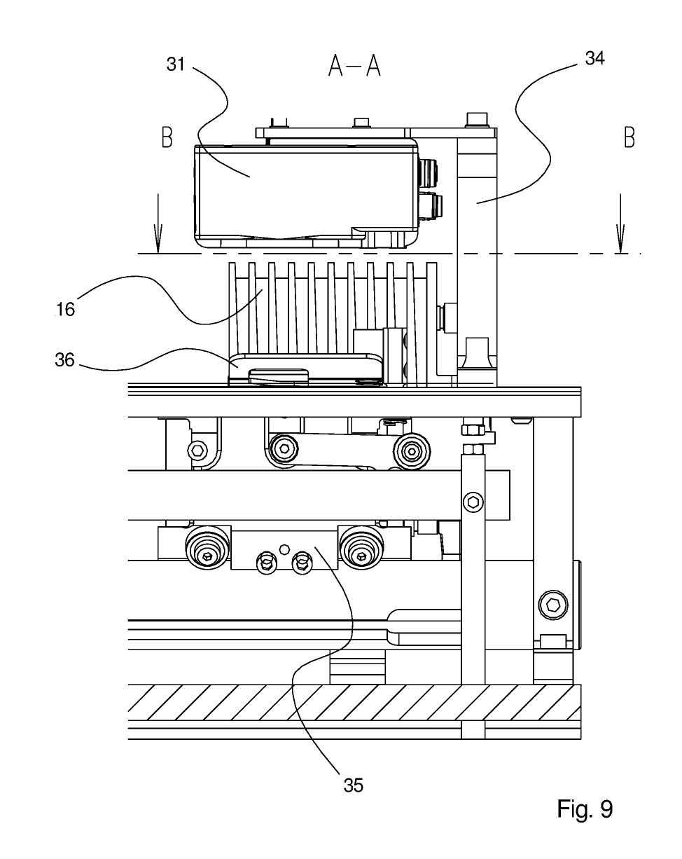

FIG. 9 depicts section A-A from the previous drawing with a camera 31 for ascertaining the position of mark 32 on sheet 7, 8, 30 being arranged above feed table 1. Camera 31 is an optical recording system, preferably with high resolution and/or appropriate analysis software. Camera 31 is particularly preferably attached to a camera mount 34, on which camera 31 can be displaced transversely to conveying direction 11. For example, camera mount 34 is mounted on a positioning unit 35 for adjustment to the format width. Positioning unit 35 may be accommodated within channel 13 or below feed table 1, for example. At the same time, camera mount 34 can also accommodate lighting device 16 for lateral edge sensor 29. Camera mount 34 preferably also bears a hold-down clamp 36 that faces the surface of sheet 7. Hold-down clamp 36 may be arranged adjacent to or within the same plane as lighting device 16, for example. Preferably, camera 31, lighting device 16, and hold-down clamp 36 can thereby be displaced jointly by positioning unit 35. Hold-down clamp 36 particularly preferably has a run-up ramp for sheets 7 transported in conveying direction 11.

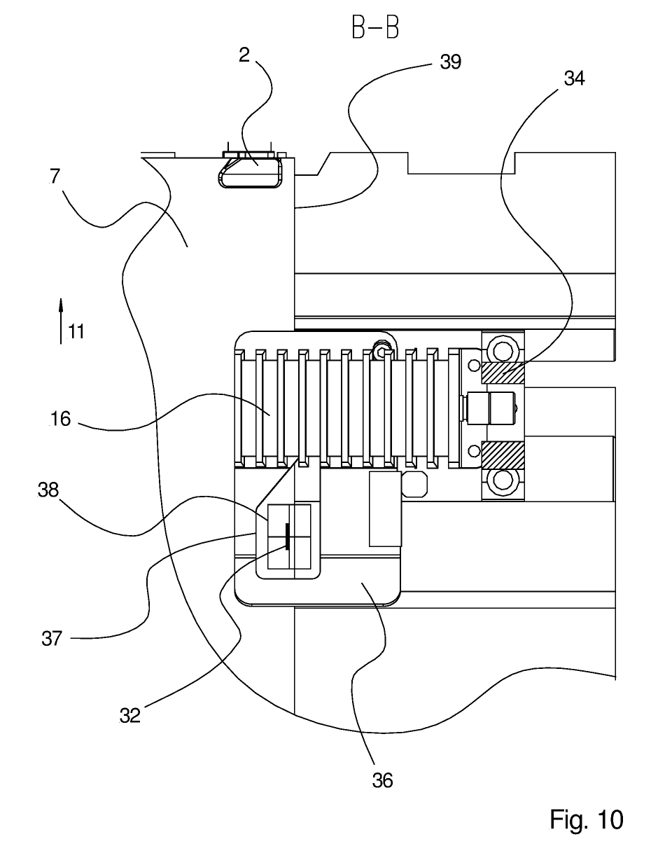

FIG. 10 depicts section B-B from the previous drawing, in which a sheet 7 to be aligned is conveyed by the upstream belt table 33 onto feed table 1 until the leading edge of said sheet rests against front lays 2, which are located in a position on feed table 1, where said sheet is halted and thus aligned along the leading edge. Hold-down clamp 36 has an opening 37, which exposes a field of view 38 of camera 31. In particular, opening 37 of hold-down clamp 36 is at least as large as or larger than the field of view 38 of camera 31. Camera 31 is always positioned such that a lateral sheet edge 39 always lies within the field of view 38 of camera 31. Camera 31 is positioned transversely to conveying direction 11, in particular based upon the sheet format arriving for processing.

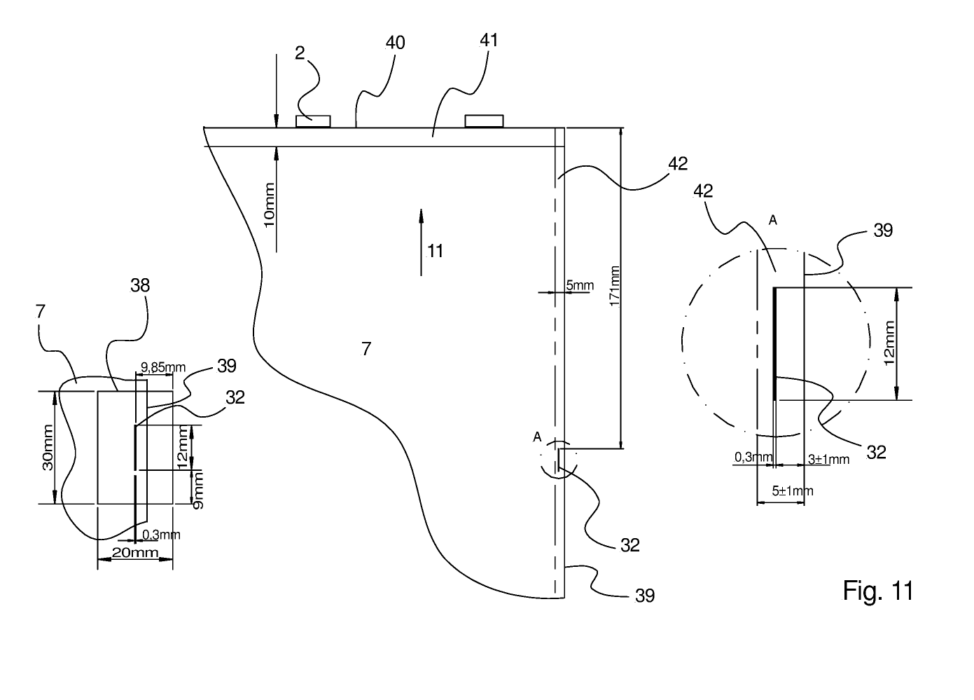

FIG. 11 shows feed table 1 with a sheet 7 having at least one register mark 32. Sheet 7 is placed against the front lays 2 or against the stop surfaces of the front lays 2. Here, said placement is accomplished by means of belt table 33 transporting sheets 7, so that sheet 7 is pushed against the front lays 2 and thus aligned along an idealized positioning line 40. Lateral edge sensor 29, which is adjusted in terms of format to the lateral region of sheet 7, can thus detect the position of lateral sheet edge 39 and can transmit measured values to analysis unit 18, so that an actuating element 19, in particular gripper system 6 of drum 5, can be actuated in and for its movement. The leading sheet edges are then secured by sheet holding system 28 of swing arm 4 along the leading gripper edge 41, which is free of printing and may measure up to 10 mm, for example. Following the gripper closure of sheet holding system 28 along the leading print-free gripper edge 41, register mark 32 is detected by camera 31, with the field of view 38 of camera 31 measuring, for example, 30 mm in conveying direction 11 and 20 mm transversely to conveying direction 11.

The register mark 32 to be detected in the field of view 38 of camera 31 may be located, in particular, within a print-free lateral region 42, which may extend up to 6 mm from lateral sheet edge 39, for example. The lateral print-free region 42 has an extension of 5 mm with a tolerance of 1 mm, for example. Register mark 32 itself can then have an extension in conveying direction 11 of 12 mm and an extension transversely to conveying direction 11 of 0.3 mm. Register mark 32 is arranged spaced from lateral sheet edge 39 in particular by a distance of at least approximately 3 mm with a tolerance of 1 mm. Register mark 32 is arranged spaced by a defined distance of approximately 171 mm, for example, from the leading edge of sheet 7, so that register mark 32 comes to rest within the field of view 38 of camera 31 when sheet 7 is in its position of placement against the front lays 2.

Regarding the procedure: The lateral edge or lateral sheet edge 39 of sheet 7 to be aligned, which is being transported or more preferably is resting against the front lays 2, is detected by lateral edge sensor 29. For this purpose, beams are emitted by lighting device 16, arranged above feed table 1, and are partially reflected by sheet 7 to be aligned and partially detected by lateral edge sensor 29. In the region that is covered by sheet 7 to be aligned, the beams emitted by lighting device 16 are reflected, mapping the position of the lateral edge to lateral edge sensor 29. Each of the lateral edge sensors 17, 29 is connected to analysis unit 18, which analyzes the signals of the at least one activated lateral edge sensor 17, 29 to determine the position of the lateral edge of the single sheet or the superimposed sheets 7, 8, 30, as described above. Analysis unit 18 may also be part of the machine controller.

The signal generated by lateral edge sensor 29 is supplied to analysis unit 18, where it is processed and optionally stored. Analysis unit 18 generates actuating signals for actuating means 19. The actuation of actuating means 19, in particular the axial pre-adjustment or rough adjustment of gripper system 6 of drum 5, is preferably carried out based upon the measured values for the sheet lateral edge from the respective lateral edge sensor 17, 29. In particular, gripper fingers 21 are prealigned with respect to the designated later pull side. With the rough positioning, in particular, the axial pull path delimited by the gripper fingers of sheet holding system 28 of swing arm 4 and by gripper fingers 21 of gripper system 6 of drum 5 can be at least nearly fully utilized or extended.

Afterward, the sheet 7 to be aligned, the leading edge of which is resting at front lays 2, is grasped by sheet accelerating device 3, in particular swing arm 4, and removed from feed table 1, and the front lays 2 are guided into a position underneath feed table 1. If sheet accelerating device 3 is configured as a swing arm 4, the sheet 7 to be aligned is clamped by sheet holding system 28 and is then removed from feed table 1. Preferably after sheet 7 has been secured by sheet holding system 28 of swing arm 4, the position of the mark 32 located on sheet 7 is detected by camera 31. Camera 31 is preferably configured to independently recognize the register mark 32, for example based upon the known shape and/or dimensions of register mark 32. The position of register mark 32 can then be detected by camera 31 or analysis unit 18, so that camera 31 can provide the measured values to analysis unit 18. Analysis unit 18 analyzes the measured values of register mark 32 for the precision alignment of actuating element 19, in particular of gripper system 6, at the same time taking into account deviations in the sheet position caused by the gripper closure of sheet holding system 28.

Once sheet 7 to be aligned has been transferred from sheet accelerating device 3 or swing arm 4 to gripper system 6 of drum 5, actuating element 19 displaces gripper system 6 far enough in the axial direction to move the lateral edge of sheet 7 to be aligned from its actual position to the target position. The values ascertained with respect to the detected register mark 32 are preferably used for precision alignment by gripper fingers 21. The aligned sheet 7 is then transferred in the target position from drum 5 to cylinder 9. While sheet 7 to be aligned is being transported to drum 5, follower sheet 8 is transported with its leading edge against the front lays 2 positioned on feed table 1 and is measured and aligned in the same way.

In a further refinement, the position of the lateral edge of sheet 7 to be aligned, which is in a state of movement, could be detected by lateral edge sensor 29 by a series of measurements, for example, with the additional generated signals being supplied to analysis unit 18, during the first phase of removal from the feed table, in which the leading edge of sheet 7 to be aligned travels a distance s, with s being approximately 2 to 10 mm. These values are preferably ignored by analysis unit 18, but may be used for a plausibility check or the like, for example.

While preferred embodiments of a sheet processing machine and a method for monitoring sheet travel, in accordance with the present invention, have been set forth full and completely hereinabove, it will be apparent to one of ordinary skill in the art that various changes could be made thereto, without departing from the true spirit and scope of the present invention, which is accordingly to be limited only by the appended claims.

1-50. (canceled)

51. A sheet processing machine, in particular a sheet-fed printing press or sheet-fed die-cutting machine, having a sheet infeed system that has at least one leading edge stop (2) for the positioning and alignment of sheets (7, 8, 30) and a device for monitoring sheet travel along a sheet transport path of the sheet infeed system, said device comprising at least one measuring device (10, 17, 29) for detecting a lateral sheet edge (39) of the sheet (7, 8, 30) and at least one sensor (31), which can be assigned to the lateral region of the sheet transport path and which is configured to optically detect and ascertain the position of a mark (32) on the sheet (7, 8, 30), wherein the measuring device (10, 17, 29) and the sensor (31) are connected to an analysis unit (18), which analyzes the signals to determine the position of the lateral edge (39) of said sheet (7, 8, 30) and emits an actuating signal to an actuating element (19, 6).

52. The sheet processing machine according to claim 51, wherein the sensor (31) is located above the sheet transport path and/or above a feed table (1) and/or is configured as a camera, a CCD camera, or a CMOS camera.

53. The sheet processing machine according to claim 51, wherein the sensor (31) is displaceable transversely to the transport path and/or to a conveying direction (11) of the sheets (7, 8, 30), and/or at least one receiver (17, 29) is arranged beneath the sheet transport path and/or is displaceable transversely to the conveying direction (11).

54. The sheet processing machine according to claim 51, wherein at least one receiver (17, 29) of the measuring device (10) is assigned to both lateral regions of the sheet transport path.

55. The sheet processing machine according to claim 51, wherein an analysis unit (18) processes the signals from a receiver (17, 29) and from the sensor (31) in succession and forwards a signal influencing the lateral position of the sheet (7, 8, 30) to a gripper system (6) of a drum (5) located downstream of an acceleration device (3, 4).

56. The sheet processing machine according to claim 51, wherein a hold-down clamp (36) that faces the sheet (7, 8, 30) and is equipped with an opening (37) for a field of view (38) is assigned to the sensor (31).

57. The sheet processing machine according to claim 51, wherein the sensor (31) along with a hold-down clamp (36), a lighting device (16), and a receiver (17, 29) can be adjusted in terms of format by means of a positioning unit (35) in a channel (13) that extends transversely to the conveying direction (11).

58. A method for monitoring sheet travel along a sheet transport path in a sheet infeed system of a sheet processing machine, in particular a sheet-fed printing press or sheet-fed die-cutting machine, having a device comprising at least one measuring device (10, 17, 29) for detecting the lateral region (39) of the sheet (7, 8, 30), characterized by at least one sensor (31), which can be assigned to the lateral region of the sheet transport path and is configured to optically detect the lateral region of a sheet (7, 8, 30), wherein the measuring device (10, 17, 29) and the sensor (31) are connected to an analysis unit (18), which processes the measured values from the measuring device (10, 17, 29) and the sensor (31) in succession, wherein the analysis unit (18) emits an actuating signal to an actuating element (19, 6).

59. The method according to claim 58, wherein the measuring device (10, 17, 29) is adjusted to the format of the sheets (7, 8, 30) and/or detects the lateral sheet edge (39).

60. The method according to claim 58, wherein the sensor (31) is configured to optically detect and ascertain the position of a mark (32) on the sheet (7, 8, 30) and/or is adjusted to the format of the sheets (7, 8, 30).

61. The method according to claim 58, wherein the respective sheet (7, 8, 30) is secured between the measurements, and/or wherein a mark (32) on the sheet (7, 8, 30) is detected after the sheet (7, 8, 30) has been positioned against at least one leading edge stop (2) and aligned.

62. The method according to claim 58, wherein the sensor (31) independently recognizes a mark (32) on a sheet (7, 8, 30), in particular from its shape and/or its dimensions.

63. The method according to claim 58, wherein the analysis unit (18) determines control commands for a rough alignment or prealignment of at least one downstream gripper system (6) from the measured values from the measuring device (10, 17, 29) and/or determines control commands for the precision alignment of at least one downstream gripper system (6) from the signals or image signals from the sensor (31).

64. The method according to claim 58, wherein, after analyzing the signals from the measuring device (10, 17, 29), the analysis unit (18) emits an actuating signal for axial prepositioning toward the designated pull side for a gripper system (6) of a downstream drum (5).

65. The method according to claim 58, wherein a first detection of the lateral region (32, 39) of a sheet (7, 8, 30) by the measuring device (10, 17, 29) is optimized for a quick analysis and a second detection of the mark (32) by the sensor (31) is optimized for a precise analysis.
